(19) United States
(12) Patent Application Publication
(10) Pub. No.: US 2006/0145426 A1
(43) Pub. Date: Jul. 6, 2006

(54) Rotary seal

(76) Inventors: Gary W. Schroeder, West Valley, UT (US); Johnathan W. Carter, Magna, UT (US)

Correspondence Address: John A. Molnar, Jr.;PARKER-HANNIFIN CORPORATION, 6035 Parkland Boulevard, Cleveland, OH, 44124-4141, US

(21) Appl. No.: 11/294,668

(22) Filed: Dec. 5, 2005

Related U.S. Application Data
(60) Provisional application No. 60/640,952, filed on Dec. 30, 2004.

(51) Int. Cl. F16J 15/32

(52) U.S. Cl. 277/559

(57) ABSTRACT

Seals for rotary sealing applications such as the sealing of shafts of rotary drill bits and other equipment such as rotary mud motors used for inshore or offshore oil or gas recovery. The seal may have a U-cup or solid geometry profile including grooves which function to retain fluid for lubricating the surfaces being sealed.

### CROSS-REFERENCE TO RELATED CASES

The present application claims the benefit of the filing date of U.S. Provisional Application Serial No. 60/640,952, filed Dec. 30, 2004, the disclosure of which is expressly incorporated herein by reference.

### BACKGROUND OF THE INVENTION

The present invention relates broadly to seals and the like for rotary sealing applications such as to seal the shafts of rotary drill bits and other equipment such as rotary mud motors used for inshore or offshore oil or gas recovery.

Fluid seals, also known as packing rings, for machine part joints are well-known in the art. A typical application therefor involves the provision of a fluid seal intermediate relatively movable surfaces such between as the outer surface of a rod or piston of a hydraulic or pneumatic cylinder, or other fluid actuator, and an internal bore or other inner surface of a stationary, surrounding housing, wherein the rod or piston reciprocates or rotates relative to the bore surface. Such seals, known in the vernacular as rod or piston seals as the case may be, conventionally are configured in a free state as a generally annular element which is molded or otherwise formed of an elastomeric or other resilient material such as a synthetic, natural, or co-polymer rubber, or a polymeric material such as a silicone, fluoropolymer, or, preferably, a polyurethane or fluoropolymer.

More specialized applications involve uses as a rotary seal between a rotating shaft and a housing within rotary drill bits or other equipment, such as rotary mud motors, used for inshore or offshore oil or gas recovery. Applications of such type are further described, for example, in U.S. Pat. Nos. 4,610,319; 5,230,520; 5,823,541; 6,109,618; 6,334,619; 6,561,520; and 6,685,194, and in European Patent No. EP 643,243.

Typically in such applications, the seal element is seated within an annular sealing gland or cavity which is provided within one of the surfaces, such as an internal bore of a housing, with the opening of the gland oriented as facing the other surface such as the outer surface of the rotatable shaft. Within the gland, the seal is interposed between the shaft, which is received coaxially through the seal, and a circumferential, peripheral side wall of the gland. As the shaft rotates about a central axis within the bore, the seal functions to contact the rotating surface of the shaft and the side wall of the gland to provide dynamic and static sealing therebetween. In this regard, as installed under stress within the gland the seal typically presents in an energized or deformed state radial forward and rearward end faces, each disposed confronting a corresponding side of the fluid pressure system, and axial inner and outer diameter faces, each defining one or more contact surfaces with a corresponding, opposing surface of the shaft and the gland. Of course, the described configurations may be reversed such that the gland is formed on the shaft.

Ideally, a seal element of the type herein involved should provide effective sealing under static and dynamic conditions, at both low and high pressure, and with a minimum of static and dynamic friction for a long, maintenance-free service life. However, particularly in the case of rotary applications, the seal must function not only to seal the against leakage, but also to lubricate the dynamic sealing surfaces.

The demands placed on rotary seals continue to increase. It therefore is believed that further improvements in the design of such seals would be well-received by various industries.

### BROAD STATEMENT OF THE INVENTION

The present invention is directed to an improved rotary seal for the dynamic sealing of shafts and other machine parts or other components or structures such as may be found in rotary drill bits and other equipment such as rotary mud motors used for inshore or offshore oil or gas recovery, and more particularly to a generally U-cup-shaped, solid geometry profile having a series of circumferential lubrication grooves formed on an inner sealing portion of the inner diameter face. The outer diameter face, in turn, is configured as having an outer sealing portion which forms an environmental or other seal for the parts being sealed.

The present invention, accordingly, comprises the construction, combination of elements, and/or arrangement of parts and steps which are exemplified in the detailed disclosure to follow. Advantages of the present invention include a seal profile having integrated sealing and lubricating functions. Additional advantages include a seal design, particularly adapted for rotary sealing applications in harsh service environments such as in oil and gas well drilling, which is both reliable and economical. These and other advantages will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a partial view in longitudinal cross-section of a first representative seal profile according to the present invention, such profile being depicted in its free state;

FIG. 2 is a partial view in longitudinal cross-section of a representative machine part assembly including the seal profile of FIG. 1, such profile being depicted in an energized state;

FIG. 3 is a partial view in longitudinal cross-section of a second representative seal profile according to the present invention, such profile being depicted in its free state;

FIG. 4 is a partial view in longitudinal cross-section of a representative machine part assembly including the seal profile of FIG. 3, such profile being depicted in an energized state;

FIG. 5 is a partial view in longitudinal cross-section of a third representative seal profile according to the present invention, such profile being depicted in its free state;

FIG. 6 is a partial view in longitudinal cross-section of a representative machine part assembly including the seal profile of FIG. 5, such profile being depicted in an energized state;

FIG. 7 is a partial view in longitudinal cross-section of a fourth representative seal profile according to the present invention, such profile being depicted in its free state; and

FIG. 8 is a partial view in longitudinal cross-section of a representative machine part assembly including the seal profile of FIG. 7, such profile being depicted in an energized state.

The drawings will be described further in connection with the following Detailed Description of the Invention.

### DETAILED DESCRIPTION OF THE INVENTION

Certain terminology may be employed in the following description for convenience rather than for any limiting purpose. For example, the terms “forward” and “rearward,” “front” and “rear,” “right” and “left,” “upper” and “lower,” “top” and “bottom,” and “right” and “left” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

For illustrative purposes, the precepts of the seal profile of the invention herein involved are described in connection with its use within a dynamic, rotary sealing assembly such as may be found in rotary drill bits and other equipment such as rotary mud motors used for inshore or offshore oil or gas recovery. In view of the discourse to follow, however, it will be appreciated that aspects of the present invention may find utility in other applications. Use within those such other applications therefore should be considered to be expressly within the scope of the present invention.

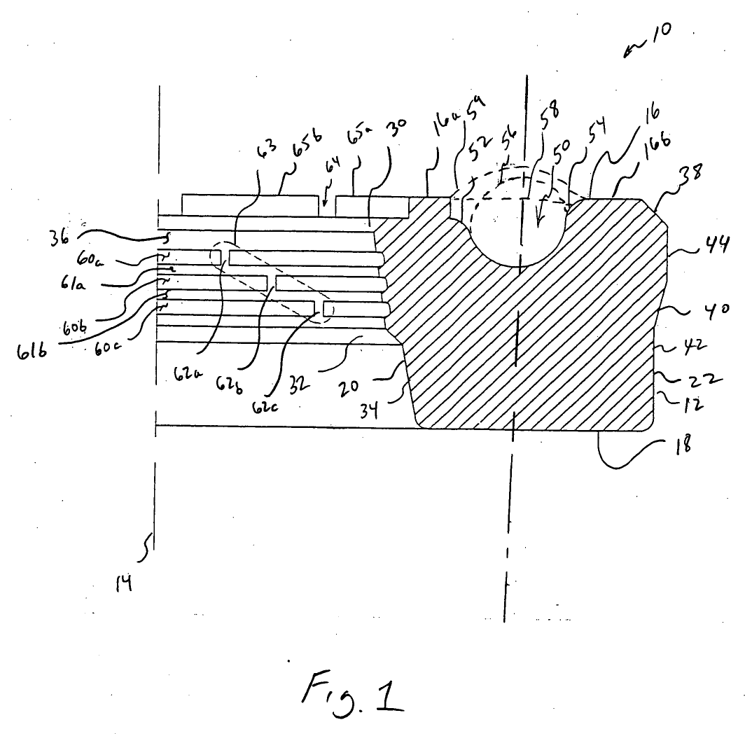

Referring then to the figures wherein corresponding reference characters are used to designate corresponding elements throughout the several views with equivalent elements being referenced with prime or sequential alphanumeric designations, a representative seal ring according to the present invention is shown generally at 10 in FIG. 1. In the unstressed or free state of the seal ring 10 which is depicted in FIG. 1, the seal ring 10 has a generally annular body, 12, which may be seen in profile to include, relative to the longitudinal seal axis referenced at 14 through the center of the ring 10, first and second end faces, 16 and 18, which are spaced-apart axially along axis 14, and which extend intermediate an inner and an outer diameter face, 20 and 22, which, in turn, are spaced-apart radially relative to the axis 14.

As may be seen, the inner diameter face 20 is formed, such as between a chamfer, 30, extending from the first end face 16 and an opposing, i.e., oppositely-angled, chafer, 32, extending from a main or other remainder or a remaining portion of inner surface, 34, of the inner diameter face 20, to define a circumferential inner sealing portion, 36, which may be generally planar as shown. The outer diameter face 22, in turn, is similarly and, in the embodiment shown, somewhat symmetrically formed, such as by the intersection a chamfer 38 extending from the first end face 16 and the opposing chamfer 40 extending from a main or other remainder or a remaining portion of outer surface, 42, to define a circumferential outer sealing portion, 44. Relative to the central longitudinal body axis referenced at 46 taken through the cross-section of the body 12, each of the sealing portions 36 and 44 extends radially outwardly therefrom for sealing contact engagement with a corresponding one of the surfaces of the assembly to be sealed, with the inner sealing portion 36 being angled radially-inwardly in extending axially from the radially-outwardly canted chamfer 30 to the oppositely-canted chamfer 32, and with the outer sealing portion 44 being disposed generally parallel to the axis 46 in extending axially between the radially-outwardly canted chamfer 38 and the oppositely-canted chamfer 40.

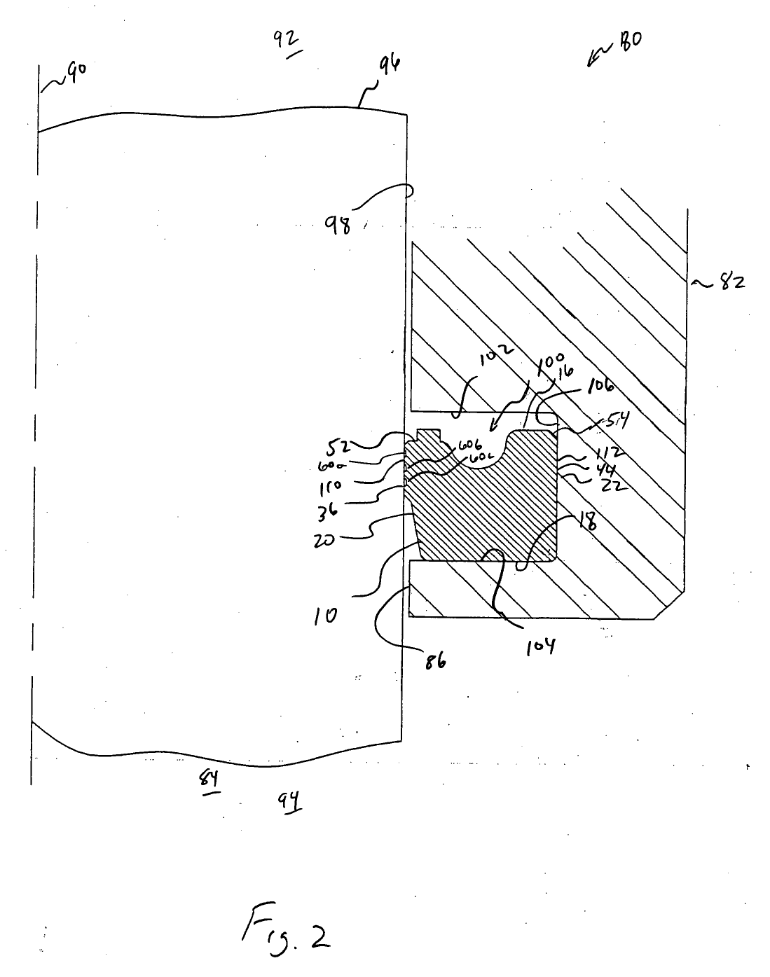

Further in the embodiment of the seal ring 10 illustrated in FIG. 1, the first end face 16 is axially birfurcated, such as by the generally parabolic-shaped, radial circumferentially-extending recess referenced at 50, into the general shape of a U-cup in defining an inner sealing arm, 52, on which the inner sealing portion 36 is carried, and an outer sealing arm, 54, on which the outer sealing portion 44 is carried, and in defining an inner first end face portion, 16a, on the inner sealing arm 52, and an outer first end face portion, 16b, on the outer sealing arm 54. Although not required, the described bifurcation, which may be generally symmetrical, i.e., equal, as shown, or asymmetrical, i.e., unequal, allows for the pre-loading or other energization of the portions 36 and 34 which may be biased by the arms 52 and 54 against the surfaces being sealed (see FIG. 2). Such biasing function may be assisted by the use of a spring or, as shown in phantom, an O-ring or other shape ring expander, 56, which may be inserted or mounted, molded-in-place, or otherwise received within the recess 50. Such pre-loading in general develops a positive loading on the sealing lips 36 and 44 which is independent of the fluid system pressure, and which therefore may provide for more effective sealing at low system pressure or vacuum. Alternatively, the ring 10 may be formed as a U-cup generally as shown but without the expander 56, or as having a more solid geometry with the first end face 16 being essentially planar, such as is depicted in phantom at 58, or as having some degree of convexity to form a dome or bead-like profile, such as is depicted in phantom at 59.

The body 12 of seal ring 10 may be conventionally molded, extruded and cut, or otherwise formed of an elastomeric material which specifically may be selected for high temperature performance, flexibility, or otherwise for compatibility with the fluid being handled. Suitable materials, which may be filled, for example, with glass or carbon, or which may be unfilled, include natural rubbers such as Hevea and thermoplastic, i.e., melt-processible, or thermosetting, i.e., vulcanizable, synthetic rubbers such as fluoropolymer, chlorosulfonate, polybutadiene, butyl, neoprene, nitrile, polyisoprene, buna-N, copolymer rubbers such as ethylene-propylene (EPR), ethylene-propylene-diene monomer (EPDM), nitrile-butadiene (NBR) and styrene-butadiene (SBR), or blends such as ethylene or propylene-EPDM, EPR, or NBR. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyolefms, polyesters, ethylene vinyl acetates, fluoropolymers, and polyvinyl chloride. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

The ring expander 56 may be formed of the same or different material as the seal ring body 12. As before, such material be selected for compatibility with the fluid being handled, and also for compatibility with the material of the body 12, and further as having a modulus, durometer, or the like selected to achieve the desired pre-loading effect.

With continuing reference to FIG. 1, the inner sealing portion 36 on the inner diameter face 20 may be seen to be formed as including a series of, i.e., two or more, circumferential grooves, referenced at 60a-c. Each of the grooves 60, which may be C-shaped, U-shaped, or otherwise shaped in cross-section, is spaced-apart axially from an adjacent groove 60, and together form a plurality of fluid channels for retaining fluid from the high pressure side of the assembly (see FIG. 2) to thereby provide lubrication between the inner sealing portion 36 and a rotating shaft or other member (FIG. 2). Each of the grooves 60 may be generally parallel to each of adjacent groove 60 and separated therefrom by a generally flat or other shaped portion, 61a-b, of the inner sealing surface 36, and together may be arranged in the generally linear pattern shown. Alternatively, the grooves may be arranged in a sinusoidal, saw tooth, or other wave-from pattern. Each of the grooves 60 may be provided as having one or more internal walls or “fluid dams,” 62a-c, formed therein to assist in retaining in a corresponding one of the grooves 60. As between the grooves 60a-c, the dams 62 may be disposed in an axially staggered configuration, referenced at 63, and, to the extent that each groove 60 is provided with more than one dam 62, the dams may be equally or otherwise radially spaced-apart in each groove. Advantageously, the retention of the fluid within the grooves 60 allows for the lubrication of the shaft or other rotating member without appreciable fluid leakage as might otherwise be caused were the lubrication to be provided by other means such as a hydrodynamic pumping action from the high pressure side to the low pressure side of the assembly.

In the illustrated embodiment of seal ring 10, the first end face 16 further may be formed as including one or more recesses or slots, one of which is referenced at 64, which may be equally or otherwise radially spaced about axis 14 as each formed between an adjacent pair of upstanding walls, two of which are referenced at 65a-b, extending axially from the inner first end face portion 16a, which otherwise may be offset axially from, i.e., lower than, the outer first end face portion 16b. Such slots 64 provide for the relief of fluid pressure which otherwise could become trapped between the end face 16 and a corresponding wall of the gland (see FIG. 2).

Referring now to FIG. 2, seal ring 10 of the present invention reappears as installed within a representative rotary machine part or other sealing assembly, shown generally at 80, which may include, for example, a stationary housing or other female part, 82, having a bore, 84, with an inner, generally annular surface, 86. Bore annular surface 86 extends along a central longitudinal axis, 90, commonly referenced with the seal ring axis at 14, intermediate an upstream high pressure side, 92, and a downstream low or atmospheric fluid pressure side, 94, of the assembly 80. Assembly 80 also includes a shaft or other male part, 96, having an outer, generally cylindrical surface, 98, which extends along axis 90 as disposed in concentric opposition to the annular surface 86 of the stationary housing part 82. Shaft 96 is rotatable, such as clockwise, counterclockwise, or both, circumferentially about axis 90.

For mountably receiving one or more seal ring 10, the annular inner surface 86 of the housing bore 84 is provided as having one or more glands, one of which is referenced at 100, machined, cast or molded, or otherwise defined therein intermediate the high and low pressure fluid sides of the assembly 80. Gland 100 is conventionally configured as having a first end wall, 102, a second end wall, 104, axially-spaced apart from the first end wall 102, and a peripheral wall, 106, which extends axially between the walls 102 and 104, and radially circumferentially about the axis 14. Depending upon the requirements of the intended application, it will be understood that gland 100 alternatively may be formed in shaft surface 98, with the profile of seal 10 being reversed, i.e., in mirror image, accordingly, i.e., with the inner sealing portion 36 thus being provided on the outer diameter face 22 and the outer sealing portion 44 being provided on the inner diameter face.

Seal ring 10 is mounted coaxially within gland 100 and effects a fluid seal between the interfacing surfaces 86 and 98. In the arrangement shown in FIG. 2, seal ring 10 is mounted, for example, with the first end face 16 thereof being disposed opposite the gland first end wall 102, and the seal ring second end face 18 being disposed opposite the gland second end wall 104. Of course, the orientation of the ring 10 within the gland 100 maybe reversed, and, optionally, a backup ring (not shown) may be received in gland 100 coaxially with the seal ring 10. Backup rings in general typically are used to delimit the extrusion of seals into the clearance gap between the interfacing surfaces being sealed. As compared to the seal itself, the backup ring typically is formed of a relatively harder, tougher, and more rigid material, such as a filled or unfilled nylon, an acetal polymer such as Delrin® (Du Pont, Wilmington, Del.), polybutylene terephthalate (PBT), polyetherketone (PEK) or the like. Within the gland 100, the seal ring inner diameter face 20 is disposed concentrically opposing the shaft surface 98, with the seal ring outer diameter face 22 being disposed concentrically opposing the gland peripheral wall 106.

Being mounted with the gland 100 as so described, the seal ring 10 is compressed, such as by the radial inward deflection of the arm 52, radially intermediate the shaft surface 98 and the gland peripheral wall 106 into the stressed or energized state depicted in FIG. 2. In such state, the seal inner sealing arm 52 is made to sealingly engage the shaft surface 98 along the sealing loci, referenced at 110, formed by the contact of the inner sealing portion 36, such as for preventing lubricating or other fluid from leaking from the high pressure side 92 of the assembly 80 while retaining such fluid within the groves 60 for lubricating the shaft surface 98. Such contact advantageously may be pre-loaded by the deflection of the arm 52 biasing the inner sealing portion 36 against the shaft surface 98 when the ring 10 is installed in the gland 100. The seal ring outer sealing arm 54, in turn, is made to sealingly engage the gland wall 106 along the sealing loci, referenced at 112, formed by the contact of the outer sealing portion 44, such as for providing an environmental seal. Such contact again may be pre-loaded by the deflection of the arm 54 biasing sealing portion 44 against the gland wall 106. Such contact along the axial length of the sealing portion 36 allows for a series of redundant annular sealing contacts to be provided, such as intermediate each of the grooves 60.

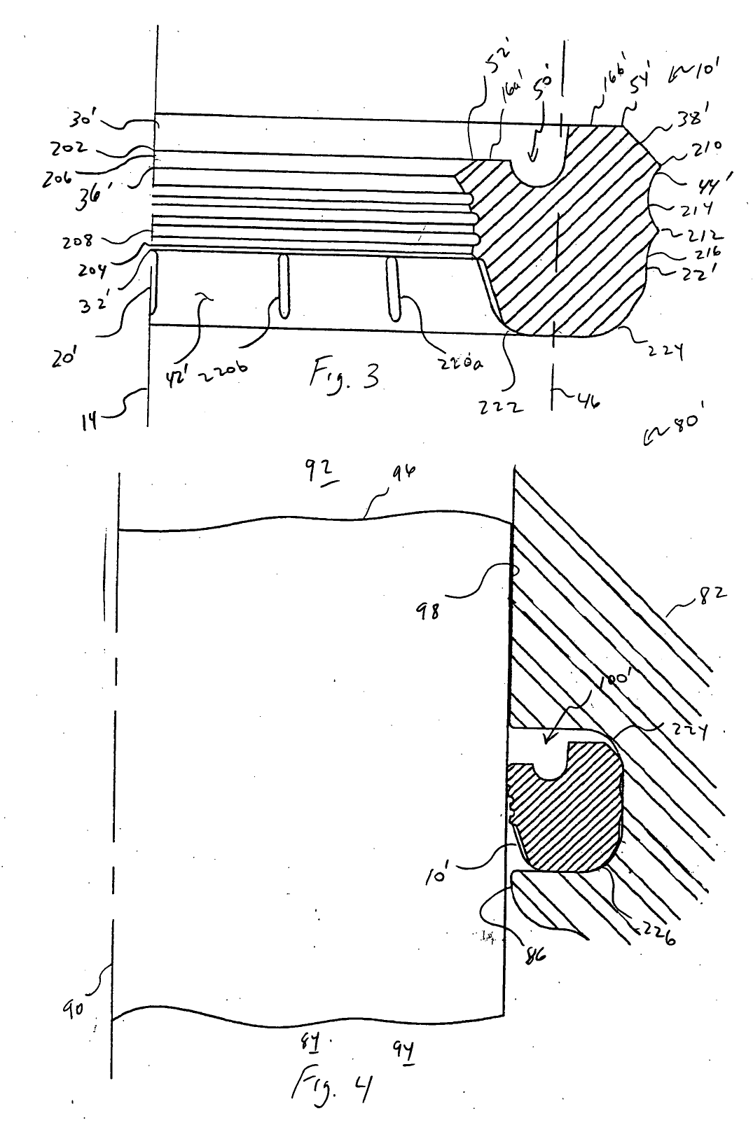

Turning now to FIG. 3, an alternative embodiment of seal ring 10 is referenced generally at 10′. Ring 10′ similarly is provided in the general form of a U-cup, but with the arms 52′ and 54′ being asymmetrically bifurcated, i.e., the recess 50′ being disposed more towards the inner sealing arm 52′. Such asymmetrical bifurcation allows for the unequal distribution of stresses as between the sealing portions 36′ and 44′, i.e., which may assist in the pre-loading of the seal 10′ when installed.

Ring 10′ further is configured with inner sealing portion 36′ on the inner diameter face 20′ being provided as having a generally curved, i.e., concave profile, which may extend axially between more defined first and second inner sealing lips, 202 and 204, respectively. In this regard, the first inner sealing lip 202 may be formed by the intersection of the chamfer 30′ and an adjoining, oppositely-canted chamfer 206, with the second inner sealing lip 204 likewise being formed by the intersection of the chamfer 32′ and an adjoining, oppositely-canted chamfer 208. Similarly, the outer diameter face 22′ may be configured as having axially-spaced apart first and second outer sealing lips, 210 and 212, such as with the first outer sealing lip 210 being formed by the intersection of chamfer 38′ and an adjoining concave or other portion, 214, with the second outer sealing lip 212 being formed by the intersection of the concave portion 214 and an adjoining concave or other portion, 216.

As also may be seen in FIG. 3, ring 10′ lacks the upstanding walls 65 (FIG. 2), with the inner first end face portion 16a′ otherwise being offset from the outer first end face portion 16b′ such that, in effect a full-length relief vent is provided along the circumference of the portion 16a′. One or more additional relief slots, two of which are referenced at 220a-b, may be formed as extending generally axially, i.e., in the direction of axis 14, along the main outer surface 42′, such as intermediate chamfer 32′ and an inner heel portion, 222, of the ring 10′. Such slots 220 may be generally equally or otherwise spaced-apart radially about axis 14.

Further as to the inner heel portion 222, such portion, along with an outer heel portion, 224, of the ring 10′, may be angled or curved so as to extend radially inwardly with respect to body axis 46. In this regard, and as may be seen with reference to FIG. 4, wherein ring 10′ is depicted in the assembly 80′ as installed in gland 100′ having curved corners, 224 and 226, such configuration may assist in the installation and use of ring 10′ within such gland 100′.

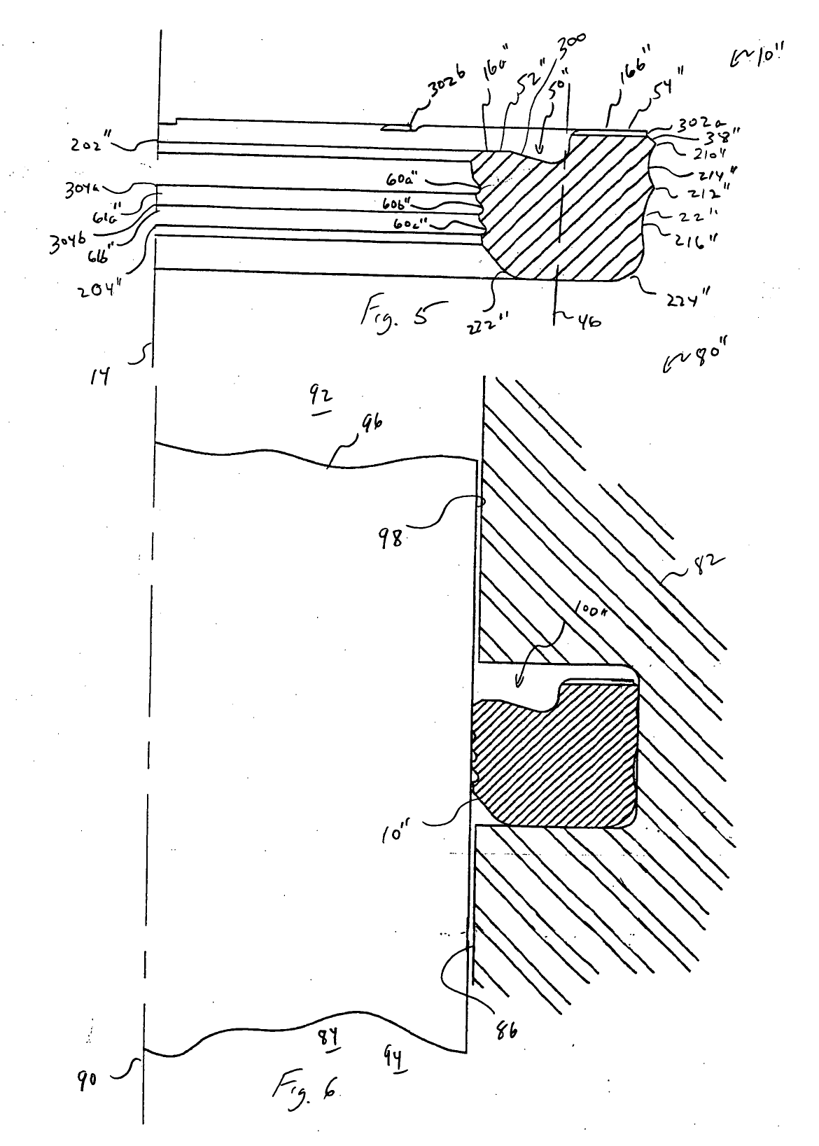

Referring next to FIG. 5, seal ring 10 now reappears at 10″, again in the general form of a U-cup, but with offset arms 52″ and 54″ being bifurcated by a recess 50″ between the inner and outer sealing arms 52″ and 54″ having a sidewall, 300, which more gradually tapers towards the inner first end face portion 16a″ of the inner sealing arm 52″. Seal 10″, moreover, may have asymmetrically-shaped heel portions 222″ and 224″, i.e., with inner heel portion 222″ being more tapered radially inwardly relative to axis 46 than the outer heel portion 224″. As did seal 10′ (FIG. 3), seal 10″ again lacks the walls 65 (FIG. 2), but has one or more relief slots, two of which are referenced at 302a-b, otherwise formed to extend radially through the outer first end face portion 16b″ of the outer sealing arm 54″. Such slots 302 may be generally equally or otherwise spaced-apart radially about axis 14.

Further regarding ring 10″, and as may be seen in FIG. 5, the portions 61a″-b″ separating the grooves 60a″-c″ each may be configured, such as a half-wave or otherwise, so as to define, in effect, additional sealing lips, 304a-b, between the first and second inner sealing lips 202″ and 204″. Similar to ring 10′ (FIG. 3), the outer diameter face 22″ of ring 10″ may be configured as having axially-spaced apart first and second outer sealing lips 210″ and 212″, such as with the first outer sealing lip 210″ being formed by the intersection of chamfer 38″ and an adjoining concave or other portion 214″, with the second outer sealing lip 212″ being formed by the intersection of the concave portion 214″ and an adjoining concave or other portion 216″.

Ring 10″ is depicted in a stressed or energized state in FIG. 6 as installed in assembly 80″ within gland 100″.

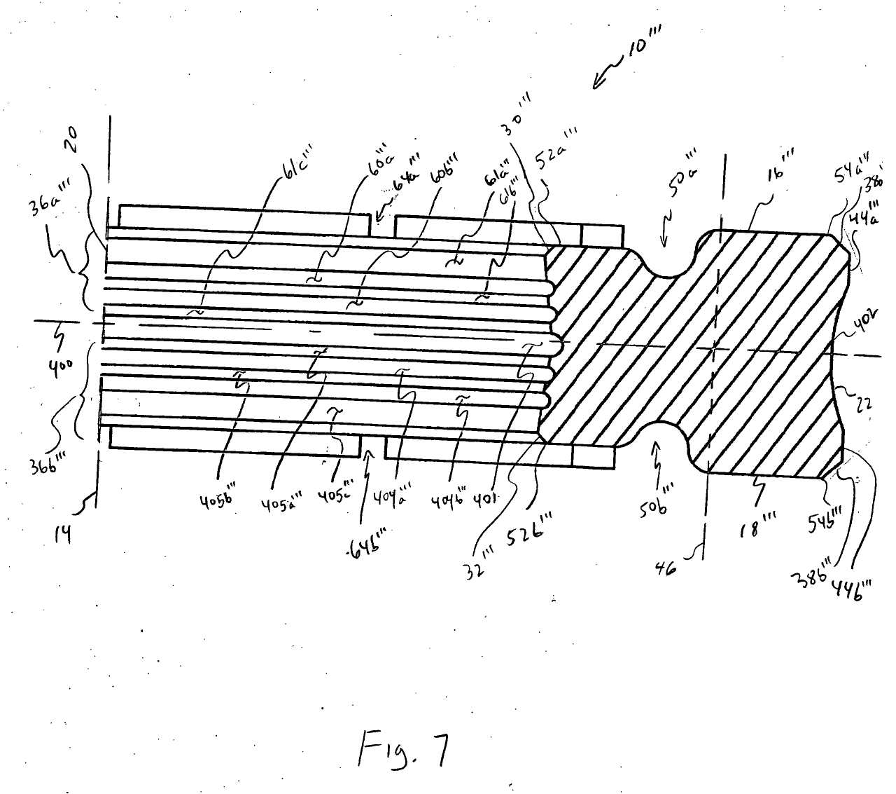

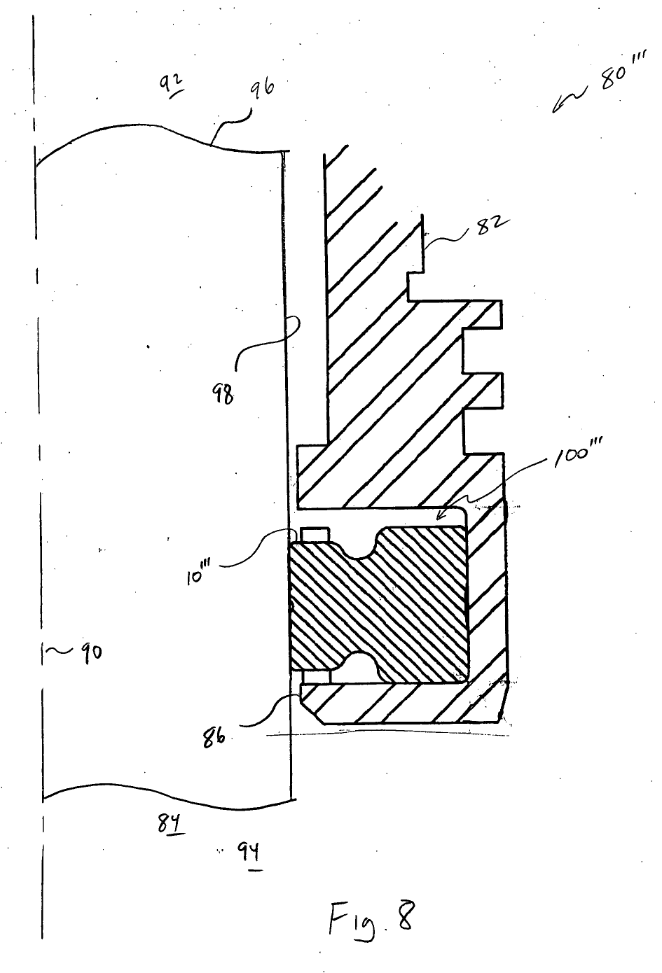

Referring next to FIG. 7, seal ring 10 reappears at 10′″ now in the form of a double-acting design which is generally symmetrical about the radial axis referenced at 400. In such ring 10′″, a pair of recesses, 50a-b′″, are provided in a corresponding one of the end faces 16′″ and 18′″ so as to bifurcate, either symmetrically or, as shown, asymmetrically, each side of the ring 10′″ in forming opposing pairs of inner and outer sealing arms 52a-b′″ and 54a-b′″. As is shown, each of the faces 16′″ and 18′″ may be formed as having slots such as at 64a′″ for face 16′″ and at 64b′″ for face 18′″.

Ring 10′″ further is configured as having a pair of opposing inner sealing portions, 36a-b′″, which may be disposed intermediate chamfers 30′″ and 32′″ and a central groove 401, and a pair of opposing outer sealing portions, 44a-b′″, which may be disposed intermediate chamfers 38a′″ and 38b′″ and a central, circumferential concave portion, 402. Each of the inner sealing portions 36a-b′″ has, respectively, a series of grooves, 60a-b′″ and 404a-b′″, separated by flats or other portions, 61a-c′″ and 405a-c′″, and each may be generally planar as shown or, alternatively, generally concave or otherwise curved. Relative to the central longitudinal body axis 46, each of the inner sealing portions 36a-b′″ are angled in the ring 10′″ radially-inwardly in extending axially from adjacent a corresponding one of the faces 16′″ and 18′″ inwardly to the axis 400.

Ring 10′″ is depicted in a stressed or energized state in FIG. 8 as installed in assembly 80′″ within gland 100′″.

It is anticipated that certain changes may be made in the present invention without departing from the precepts herein involved. Accordingly, the foregoing description should be interpreted as illustrative and not in a limiting sense. All references including any priority documents cited herein are expressly incorporated by reference.

What is claimed is:

1. A seal ring for installation within an assembly having a source of fluid on a high pressure side thereof, and including a female part having a generally annular female part surface which extends along a central longitudinal assembly axis, and a male part having a generally cylindrical male part surface disposed in concentric opposition to the female surface, one of the parts being rotatable relative to the other one of the parts about the assembly axis, and one of the part surfaces having a gland defined therein in confrontation with the other part surface, the gland having a first end wall and a second end wall spaced-apart axially from the first end wall, and a peripheral wall extending axially between the first and second end walls and radially circumferentially about the assembly axis, the seal ring comprising a generally annular body extending around a central seal axis and configured to be receivable within the gland coaxially with the assembly axis intermediate the male and female parts, the body having a radial first end face disposable opposite the gland first end wall, and a radial second end face spaced-apart axially from the first end face along a central longitudinal body axis taken through an axial cross-section of the body, and being disposable opposite the gland second end wall, and the body having an inner diameter face extending axially intermediate the first and second end face and disposable opposite a corresponding one of the gland peripheral wall and the other part surface, and an outer diameter face spaced-apart radially from the inner diameter face and extending intermediate the first and second end face, and being disposable opposite the other one of the gland peripheral wall and the other part surface, the inner diameter face having a circumferential inner sealing portion, and the outer diameter face having a circumferential outer sealing portion,
wherein a first one of the inner and outer sealing portions is disposable opposite the gland peripheral wall, and a second one of the inner and outer sealing portions is disposable opposite the other part surface,
wherein the second one of the inner and outer sealing portions is formed as having series of grooves, each of the grooves extending circumferentially about the central seal axis and being spaced-apart axially from each adjacent one of the grooves, fluid from the high pressure side of the assembly being retained within the grooves as the one of the parts rotates relative to the other one of the parts, and
wherein the first one of the inner and outer sealing portions is compressible radially against the gland peripheral wall to sealingly contact the same, and the second one of the inner and outer sealing portions is compressible radially against the other part surface to sealingly contact the same.

2. The seal ring of claim 1 wherein the body is formed of an elastomeric polymeric material.

3. The seal ring of claim 1 wherein the first end face is bifurcated axially by a circumferentially extending recess in defining an inner sealing arm and an outer sealing arm, the inner sealing arm being located on the inner sealing arm, and the outer sealing arm being located on the outer sealing arm, the inner sealing arm being deflectable radially inwardly against the corresponding one of the gland peripheral wall and other part surface for biasing the inner sealing portion in contact thereagainst, and the outer sealing arm being deflectable radially against the corresponding other one of the gland peripheral wall and the other part surface for biasing the outer sealing portion in contact thereagainst.

4. The seal ring of claim 3 wherein an inner portion of the first end face is defined on the inner sealing arm, and an outer portion of the first end face is defined on the outer sealing arm, the first end face inner and outer portions being axially offset.

5. The seal ring of claim 3 wherein:
an inner portion of the first end face is defined on the inner sealing arm, and an outer portion of the first end face is defined on the outer sealing arm; and
at least one fluid relief slot is formed to extend radially through one of the first end face inner and outer portions.

6. The seal ring of claim 1 wherein the second one of the inner and outer sealing portions extends axially intermediate first and second sealing lips, each of the sealing lips extending radially outwardly from the corresponding inner or diameter face and being compressible radially against the other part surface to sealingly contact the same.

7. The seal ring of claim 1 wherein the first one of the inner and outer sealing portions is formed as having at least one sealing lip extending radially outwardly from the corresponding inner or outer diameter face and being compressible radially against the gland peripheral wall to sealingly contact the same.

8. The seal ring of claim 1 wherein the second one of the inner and outer sealing portions has a generally concave profile.

9. The seal ring of claim 1 wherein the second one of the inner and outer sealing portions is angled radially-inwardly relative to the body axis.

10. The seal ring of claim 1 wherein at least one of the grooves has at least one wall formed therein, the wall forming a dam for the fluid being retained in the groove.

11. The seal ring of claim 1 wherein each of the grooves has at least one wall formed therein, each wall in each groove being disposed relative to a corresponding wall in each adjacent groove to define an axially staggered arrangement.

12. The seal ring of claim 1 wherein each of the grooves is separated from each adjacent groove by a portion of the second one of the first and second sealing surfaces, one or more of the separating portions being configured to define a sealing lip, each of the sealing lips being compressible radially against the other part surface to sealingly contact the same.

13. The seal ring of claim 1 wherein at least one fluid relief slot is formed to extend axially along a portion of the corresponding inner or outer diameter face having the second one of the inner and outer sealing portions.

14. The seal ring of claim 1 wherein:
the inner or outer diameter face having the second one of the inner and outer sealing portions is formed as having a pair of said sealing portions each extending from adjacent a corresponding one of the radial first and second end faces towards a radial axis of the seal ring; and
each of said pair of said sealing portions is formed as having a series of said grooves.

15. The seal ring of claim 14 wherein each of said pair of said sealing surfaces is angled radially-inwardly relative to the body axis.

16. The seal ring of claim 14 wherein each of the first and the second end face is bifurcated axially by a circumferentially extending recess in defining opposing first and second inner sealing arms and opposing first and second outer sealing arms, the inner sealing arms each having a said inner sealing portion, and the outer sealing arms each having a said outer sealing portion, the inner sealing arms being deflectable radially inwardly against the corresponding one of the gland peripheral wall and other part surface for biasing the inner sealing portions in contact thereagainst, and the outer sealing arms being deflectable radially against the corresponding other one of the gland peripheral wall and the other part surface for biasing the outer sealing portion in contact thereagainst.

17. An assembly having a source of fluid on a high pressure side thereof comprising:
a female part having a generally annular female part surface which extends along a central longitudinal assembly axis;
a male part having a generally cylindrical male part surface disposed in concentric opposition to the female surface, one of the parts being rotatable relative to the other one of the parts about the assembly axis, and one of the part surfaces having a gland defined therein in confrontation with the other part surface, the gland having a first end wall and a second end wall spaced-apart axially from the first end wall, and a peripheral wall extending axially between the first and second end walls and radially circumferentially about the assembly axis; and
a seal ring received within the gland intermediate the male and female parts, the seal ring comprising a generally annular body extending around a central seal axis disposed coaxially with the assembly axis, the body having a radial first end face disposed opposite the gland first end wall, and a radial second end face spaced-apart axially from the first end face along a central longitudinal body axis taken through an axial cross-section of the body, and being disposed opposite the gland second end wall, and the body having an inner diameter face extending axially intermediate the first and second end face and disposed opposite a corresponding one of the gland peripheral wall and the other part surface, and an outer diameter face spaced-apart radially from the inner diameter face and extending intermediate the first and second end face, and being disposed opposite the other one of the gland peripheral wall and the other part surface, the inner diameter face having a circumferential inner sealing portion, and the outer diameter face having a circumferential outer sealing portion,
wherein a first one of the inner and outer sealing portions is disposed opposite the gland peripheral wall, and a second one of the inner and outer sealing portions is disposed opposite the other part surface,
wherein the second one of the inner and outer sealing portions is formed as having series of grooves, each of the grooves extending circumferentially about the central seal axis and being spaced-apart axially from each adjacent one of the grooves, fluid from the high pressure side of the assembly being retained within the grooves as the one of the parts rotates relative to the other one of the parts, and
wherein the first one of the inner and outer sealing portions is compressible radially against the gland peripheral wall to sealingly contact the same, and the second one of the inner and outer sealing portions is compressible radially against the other part surface to sealingly contact the same.

18. The assembly of claim 17 wherein the seal ring body is formed of an elastomeric polymeric material.

19. The assembly of claim 17 wherein the seal ring first end face is bifurcated axially by a circumferentially extending recess in defining an inner sealing arm and an outer sealing arm, the inner sealing arm being located on the inner sealing arm, and the outer sealing arm being located on the outer sealing arm, the inner sealing arm being deflected radially inwardly against the corresponding one of the gland peripheral wall and other part surface for biasing the inner sealing portion in contact thereagainst, and the outer sealing arm being deflected radially against the corresponding other one of the gland peripheral wall and the other part surface for biasing the outer sealing portion in contact thereagainst.

20. The assembly of claim 19 wherein an inner portion of the seal ring first end face is defined on the inner sealing arm, and an outer portion of the seal ring first end face is defined on the outer sealing arm, the first end face inner and outer portions being axially offset.

21. The assembly of claim 19 wherein:
an inner portion of the seal ring first end face is defined on the inner sealing arm, and an outer portion of the seal ring first end face is defined on the outer sealing arm; and
at least one fluid relief slot is formed to extend radially through one of the first end face inner and outer portions.

22. The assembly of claim 17 wherein the second one of the seal ring inner and outer sealing portions extends axially intermediate first and second sealing lips, each of the sealing lips extending radially outwardly from the corresponding inner or diameter face and being compressible radially against the other part surface to sealingly contact the same.

23. The assembly of claim 17 wherein the first one of the seal ring inner and outer sealing portions is formed as having at least one sealing lip extending radially outwardly from the corresponding inner or outer diameter face and being compressible radially against the gland peripheral wall to sealingly contact the same.

24. The assembly of claim 17 wherein the second one of the seal ring inner and outer sealing portions has a generally concave profile.

25. The assembly of claim 17 wherein the second one of the seal ring inner and outer sealing portions is angled radially-inwardly relative to the body axis.

26. The assembly of claim 17 wherein at least one of the seal ring grooves has at least one wall formed therein, the wall forming a dam for the fluid being retained in the groove.

27. The assembly of claim 17 wherein each of the seal ring grooves has at least one wall formed therein, each wall in each groove being disposed relative to a corresponding wall in each adjacent groove to define an axially staggered arrangement.

28. The assembly of claim 17 wherein each of the seal ring grooves is separated from each adjacent groove by a portion of the second one of the first and second sealing surfaces, one or more of the separating portions being configured to define a sealing lip, each of the sealing lips being compressible radially against the other part surface to sealingly contact the same.

29. The assembly of claim 17 wherein at least one fluid relief slot is formed in the seal ring to extend axially along the a portion of the corresponding inner or outer diameter face having the second one of the inner and outer sealing portions.

30. The assembly of claim 17 wherein:
the seal ring inner or outer diameter face having the second one of the inner and outer sealing portions is formed as having a pair of said sealing portions each extending from adjacent a corresponding one of the radial first and second end faces towards a radial axis of the seal ring; and
each of said pair of said sealing portions is formed as having a series of said grooves.

31. The assembly of claim 30 wherein each of said pair of said sealing surfaces is angled radially-inwardly relative to the body axis.

32. The assembly of claim 30 wherein each of the seal ring first and the second end face is bifurcated axially by a circumferentially extending recess in defining opposing first and second inner sealing arms and opposing first and second outer sealing arms, the inner sealing arms each having a said inner sealing portion, and the outer sealing arms each having a said outer sealing portion, the inner sealing arms being deflectable radially inwardly against the corresponding one of the gland peripheral wall and other part surface for biasing the inner sealing portions in contact thereagainst, and the outer sealing arms being deflectable radially against the corresponding other one of the gland peripheral wall and the other part surface for biasing the outer sealing portion in contact thereagainst.
